(19) United States
(12) Patent Application Publication
(10) Pub. No.: US 2006/0141206 A1
(43) Pub. Date: Jun. 29, 2006

(54) Light board material

(75) Inventor: Jung-Huan Hwang, Taipei City (TW)

Correspondence Address: BACON & THOMAS, PLLC, 625 SLATERS LANE, FOURTH FLOOR, ALEXANDRIA, VA, 22314, US

(73) Assignee: KENMARK INDUSTRIAL CO., LTD., Taipei City (TW)

(21) Appl. No.: 11/135,325

(22) Filed: May 24, 2005

(30) Foreign Application Priority Data
Dec. 23, 2004 (CN) 2004201205867

(51) Int. Cl. B32B 3/00

(52) U.S. Cl. 428/73

(57) ABSTRACT

This invention provides a light board material including: a board having a top and a bottom, and the bottom has a recess; a reinforced structure that is disposed inside the recess of the board; and a cover that covers the recess that has been disposed with the reinforced structure. By means of the reinforced structure and the structure of the reinforced board so made, the board becomes structurally stronger, and the weight of the board is also effectively lowered, thereby lowering carrier charges and alleviating the harm that may have on the human body during assembling or carrying.

### BACKGROUND OF THE INVENTION

1. Field of the Invention

The present invention relates to a light board material, and more particularly, to a light board material that is internally disposed with a reinforced structure to achieve a light and strong structure, thereby effectively lowering carrier charges.

2. Description of Prior Art

In Europe and America where the notion of DIY (Do It Yourself) is prevalent, people enjoy assembling household bookcases, kitchen cabinets and furniture all on their own. Generally speaking, the plate surfaces or bottom structures of TV cabinets, office desks or dining tables are all made of thick board materials, so that they are relatively heavier. If self-assembled furniture is purchased, and if the plate surface or the bottom structure of the furniture is made of such thick board materials, the furniture has to be carried by carriers because it becomes heavier. However, carrier charges are generally calculated based on the weight of the thing to be carried, so that extra charges are required for carrying the heavier furniture. Hence, if it is possible to lower the weight of board materials, unnecessary charges can be avoided. Moreover, lighter board materials can make thicker boards, thereby enhancing their aesthetic appeal and value, without causing difficulty in carrying and any harm that may have on the human body during carrying caused by the overweight of boards.

### SUMMARY OF THE INVENTION

It is the primary object of the present invention to provide a structurally strong but light board material that can effectively lower the carrier charges for carrying the furniture that is made of such board material and also the efforts required for carrying the furniture so made.

To achieve the above object of the present invention, the light board material comprises at least a board having a top and a bottom, and the bottom comprises a recess; a reinforced structure that is disposed inside the recess of the board; a cover that covers the recess that has been disposed with the reinforced structure. By means of the reinforced structure and the structure of the reinforced board so made, the board becomes structurally stronger, and the weight of the board is also effectively lowered, thereby lowering carrier charges.

A preferred embodiment of the present invention discloses the recess of the light board material further comprising at least one rib horizontally disposed in the recess to be used for coupling other assembly parts, and then capable of adding one rib to the border of the board to facilitate the shaping of the board into an arc for subsequent processing.

Another preferred embodiment of the present invention discloses the light board material that is capable of reducing the weight of the original board material by approximately one half.

Another preferred embodiment of the present invention discloses the reinforced structure of the light board that is preferably made in a beehive structure and preferably made of paper, but can also be made in a cylindrical, square, or any geometric structure and made of other materials such as plastics.

The structures and the technical means adopted by the present invention to achieve the above and other objects can be best understood by referring to the following detailed description of the preferred embodiments and the accompanying drawings. But it is to be understood that the accompanying drawings and examples are used only for description, but not for restricting or limiting the present invention.

### BRIEF DESCIPTION OF THE DRAWINGS

FIG. 1 is a perspective view of a light board material according to a preferred embodiment of the present invention taken from the top.

FIG. 2 is an exploded view of the light board material of FIG. 1.

FIG. 3 is a top view of the light board material of FIG. 1, which is uncovered.

FIG. 4 is a perspective view of the light board material of FIG. 1 taken from the bottom.

FIG. 5 is a top view of another embodiment of the light board material of FIG. 3 disposed with a variance of the reinforced structure.

FIG. 6 is a top view of another embodiment of the light board material of FIG. 3 disposed with another variance of the reinforced structure.

FIG. 7 is an exploded view of the light board material according to another embodiment of the present invention.

FIG. 8 is an application of the light board material of the present invention on a TV cabinet.

### DETAILED DESCRIPTION OF THE PREFERRED EMBODIMENTS

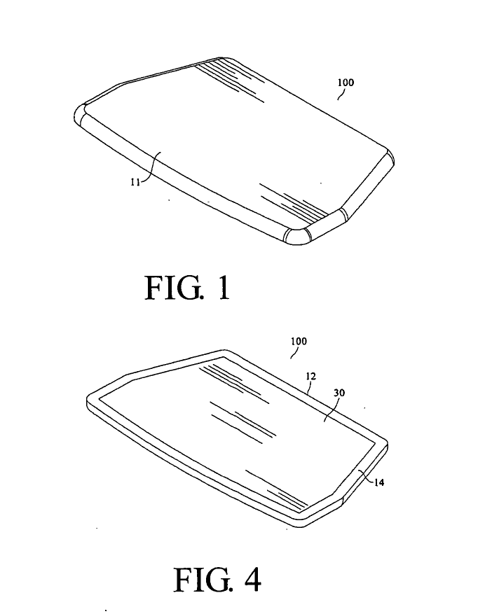

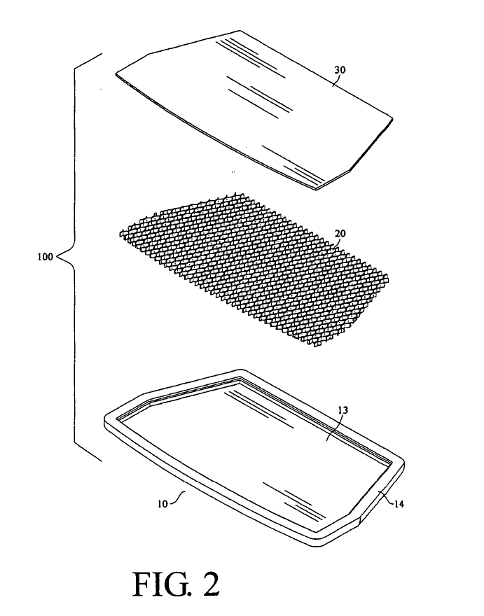

As shown in FIG. 1 and FIG. 2, the light board material 100 of the present invention primarily comprises a board 10 having a top 11 and a bottom 12, and the bottom 12 comprises a recess 13; a reinforced structure 20, for example as a beehive paper structure, that is disposed inside the recess 13 of the board 10; a cover 30 that covers the recess 13 that has been disposed with the reinforced structure 20 to be used for sealing the recess 13.

In FIG. 2, this shows an exploded view of the light board material 100 of the present invention taken from the bottom, the reinforced structure 20 is disposed inside the recess 13 of the bottom 12, such that the top of the reinforced structure 20 is separated from the top of the side frame 14 of the bottom 12 by a distance same as the thickness of the cover 30; the cover 30 is covered and disposed on the reinforced structure 20 inside the recess 13 along the inside of the side frame 14 and then fixed on the periphery of the bottom 12 by gun nails, so as to complete the construction of the light board material 100 of the present invention.

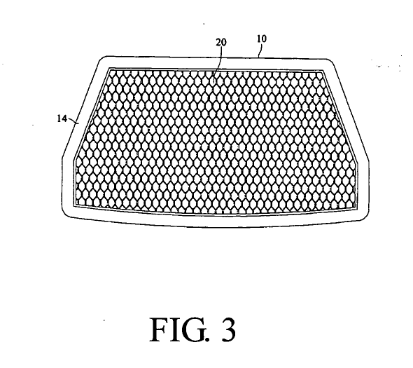

In line with FIG. 4, FIG. 3 is a top view of the light board material 100 not yet covered with the cover 30 of the present invention, the shape of the reinforced structure 20 and the cover 30 is adjusted to match the shape of the recess 13 of the bottom 12 in the board 10, so that the reinforced structure 20 spreads all over the recess 13 of the entire bottom 12, so as to achieve reinforcement effects. In this way, the structure of the board 10 becomes stronger. Moreover, the cover 30 is covered and disposed on the beehive paper board 20 inside the recess 13 along the inside of the side frame 14, so as to complete the construction of the light board material 100 as shown in FIG. 4.

The top 11 of the board 10 is a plate and can be used for operations or disposing things, or used as a base or a vertically erected sideboard. By means of the reinforced structure 20 internally disposed inside the light board material 100, reinforcement effects can be achieved, and the weight of the board 10 can also be reduced by approximately one half, thereby reducing carrier charges.

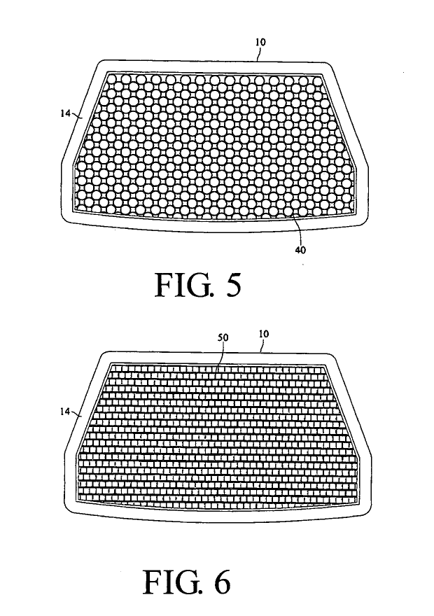

Please refer to FIG. 5, shows a variance of the reinforced structure of the light board material 100 of the present invention, in which a reinforced structure 40 is formed by a plurality of mutually independent cylinders and moreover, has the functions of the beehive reinforced structure 20.

Please refer to FIG. 6, shows another variance of the reinforced structure of the light board material 100 of the present invention, in which a reinforced structure 50 is formed by a plurality of mutually independent square structures and moreover, has the functions of the beehive reinforced structure 20.

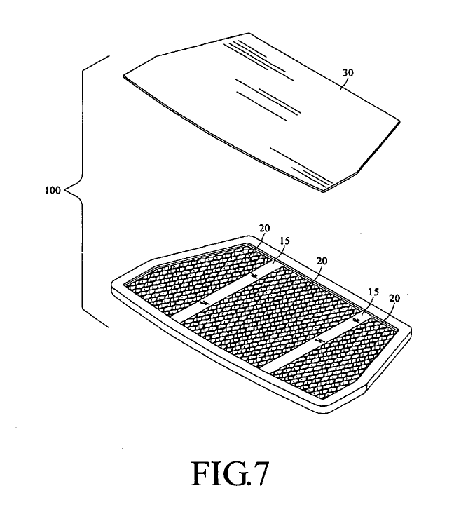

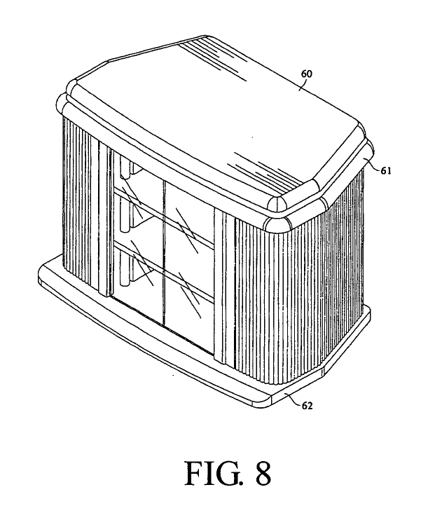

Please refer to FIG. 7, it is another embodiment of the light board material 100 of the present invention, primarily comprising a board 10, a plurality of ribs 15, a plurality of reinforced structures 20 and a cover 30. The board 10 comprises a top 11 and a bottom 12, and the top 11 is a plate used for operations or disposing things, or used as a base; the bottom 12 comprises a recess 13, and the ribs 15 are horizontally disposed on the two sides of the recess 13 in the bottom 12 and is used for coupling to a support pillar (not shown in the figure). The rib 15 is horizontally disposed in the recess 13 so that the recess 13 is partitioned into a plurality of sections, and then the plurality of the reinforced structures 20 constructed in different shapes partitioned in different sections are then disposed in the corresponding sections partitioned by the recess 13. The cover 30 is covered on the reinforced structure 20 inside the recess 13, so as to achieve the construction of the light board material 100. Furthermore, the embodiment can be varied in line with FIG. 5 and FIG. 6, to achieve the same effects.

Please refer to FIG. 8 that shows a perspective view of the light board material 100 of the present invention applied to a TV cabinet. The TV cabinet comprises a rotatable substrate 60, an upper substrate 61, several layers of partitions and a lower substrate 62. The rotatable substrate 60, the upper substrate 61 and the lower substrate 62 can all be made from the light board material 100 of the present invention, and moreover, ribs are disposed on the corresponding positions for connecting the upper substrate 61, the lower substrate 62 and several layers of partitions in the center, so that the TV cabinet is assembled in a lighter but stronger structure.

The effects of the light board materials of the present invention are achieved by disposing a reinforced structure inside the recess on the bottom of the board so as to reinforce the structure of the board. The board becomes structurally stronger and the weight of the board can also be effectively lowered. The carrier charges is also reduced.

While the invention has been described by way of examples and in terms of preferred embodiments, it is to be understood that the invention is not limited thereto. To the contrary, it is intended to carry out various modifications and similar arrangements and procedures, and the scope of the appended claims therefore should be accorded the broadest interpretation so as to encompass all such modifications and similar arrangements and procedures. For example, the disposition of ribs can be adjusted according to the different locations of the supports, which can easily be achieved by those who are familiar with the prior art.

What is claimed is:

1. A light board material comprising:
a board having a top and a bottom, said bottom having at least a recess; a reinforced structure disposed in said recess of said bottom; and a cover that covers and is disposed on a beehive paper board inside the said recess; by means of said reinforced structure, the structure of said board is reinforced, and said board becomes structurally stronger, the weight of said board can also be effectively reduced, thereby lowering carrier charges.

2. The light board material as claimed in claim 1, further comprises at least one rib horizontally disposed in said recess of said bottom.

3. The light board material as claimed in claim 1, wherein said reinforced structure is constructed in the following structure: a beehive structure, a cylindrical structure, a square structure and other proper shapes.
